(19) United States
(12) Patent Application Publication
(10) Pub. No.: US 2025/0023175 A1
(43) Pub. Date: Jan. 16, 2025

(54) POWER STORAGE DEVICE

(71) Applicant: TOYOTA JIDOSHA KABUSHIKI KAISHA, Toyota-shi (JP)

(72) Inventor: Shogo AWANO, Toyota-shi (JP)

(73) Assignee: TOYOTA JIDOSHA KABUSHIKI KAISHA, Toyota-shi (JP)

(21) Appl. No.: 18/754,324

(22) Filed: Jun. 26, 2024

(30) Foreign Application Priority Data
Jul. 10, 2023 (JP) 2023-112876

(51) Int. Cl. H01M 50/242; H01M 50/209; H01M 50/271; H01M 50/289; H01M 50/342

(52) U.S. Cl. CPC H01M 50/242; H01M 50/209; H01M 50/271; H01M 50/289; H01M 50/3425; H01M 2220/20

(57) ABSTRACT

A power storage device includes: a plurality of power storage modules arranged in a first direction; a housing case including an upper case; and a plurality of support members, an exhaust valve is provided on one side, in the first direction, of the upper case, the upper case includes a one-side top plate portion, an other-side top plate portion, and a center-side top plate portion that are located, in a second direction, on one side, on the other side, and in a center portion, respectively, the center-side top plate portion protrudes upward relative to the one-side top plate portion and the other-side top plate portion, and the plurality of support members include first support members supporting the one-side top plate portion and the other-side top plate portion, and a second support member supporting the center-side top plate portion.

### CROSS REFERENCE TO RELATED APPLICATIONS

This nonprovisional application is based on Japanese Patent Application No. 2023-112876 filed on Jul. 10, 2023 with the Japan Patent Office, the entire contents of which are hereby incorporated by reference.

### BACKGROUND

### Field

The present disclosure relates to a power storage device, and more particularly, to a power storage device mounted on a vehicle.

### Description of the Background Art

As a conventional power storage device, Japanese Patent Laying-Open No. 2020-113528 discloses a configuration including a support member extending upward from a rigid body provided in a lower case to support an upper case from a back surface.

### SUMMARY

In the power storage device disclosed in Japanese Patent Laying-Open No. 2020-113528, the support member is provided to support the center portion of the upper case. Therefore, there is room for improvement of the support member in order to improve the vibration isolation property of the upper case against vibration of the vehicle. In addition, there is room for improvement in a configuration in which the gas discharged from the power storage module housed in the housing case is easily discharged to the outside of the housing case.

The present disclosure has been made in view of the above-described problems, and an object of the present disclosure is to provide a power storage device capable of sufficiently securing an exhaust path of a gas discharged from a power storage module while improving the vibration isolation property of an upper case.

A power storage device based on the present disclosure includes: a plurality of power storage modules arranged in a first direction orthogonal to a top-bottom direction; a housing case including an upper case and housing the plurality of power storage modules; and a plurality of support members that are arranged in at least one of gaps each located between the power storage modules adjacent to each other in the first direction, and support the upper case, and an exhaust valve that allows gas in the housing case to be discharged is provided on one side, in the first direction, of the upper case. The upper case includes a one-side top plate portion located on one side in a second direction orthogonal to the first direction, an other-side top plate portion located on the other side in the second direction, and a center-side top plate portion located in a center portion in the second direction. The one-side top plate portion, the other-side top plate portion, and the center-side top plate portion each extend in the first direction. The center-side top plate portion protrudes upward relative to the one-side top plate portion and the other-side top plate portion. The plurality of support members include a plurality of first support members supporting the one-side top plate portion and the other-side top plate portion, and one or more second support members supporting the center-side top plate portion.

In the above-described configuration, the one-side top plate portion and the other-side top plate portion of the upper case can be supported by the plurality of first support members, and the center-side top plate portion of the upper case can be supported by the one or more second support members. Thus, the upper case can more firmly be supported, and the vibration isolation property of the upper case can be improved. Further, the center-side top plate portion protrudes upward relative to the one-side top plate portion and the other-side top plate portion, and therefore, the gap between the center-side top plate portion and the power storage modules is larger than the gap between the one-side top plate portion and the power storage modules and the gap between the other-side top plate portion and the power storage modules. Thus, even when gas is discharged from the power storage modules, an exhaust passage in which gas can move can be ensured sufficiently. In addition, the plurality of first support members and the one or more second support members are arranged separately from each other, and therefore, the space between the support members allows gas to move, which also ensures a sufficient exhaust passage for gas.

In the power storage device based on the present disclosure, each of the one-side top plate portion and the other-side top plate portion may include a first housing protrusion which protrudes upward and in which an upper end of the first support member is received. The center-side top plate portion may include one or more second housing protrusions which protrude upward and in which respective upper ends of the one or more second support members are received.

In the above-described configuration, the upper end of the first support member is received in the first housing protrusion, and respective upper ends of one or more second support members are received in the one or more second housing protrusions. Thus, the plurality of first support members and the one or more second support members can be restrained from moving, and the vibration isolation property of the upper case can further be improved.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing a vehicle equipped with a power storage device according to an embodiment.

FIG. 2 is a schematic perspective view showing the power storage device according to the embodiment.

FIG. 3 is a plan view showing the inside of the power storage device according to the embodiment.

FIG. 4 is a cross-sectional view taken along line IV-IV shown in FIG. 2.

FIG. 5 is a diagram showing a state in which gas moves in a housing case when the gas is discharged from the power storage module in the power storage device according to the embodiment.

### DESCRIPTION OF THE PREFERRED EMBODIMENTS

Hereinafter, embodiments of the present disclosure will be described in detail with reference to the drawings. In the following embodiments, the same or common parts are denoted by the same reference numerals in the drawings, and the description thereof will not be repeated.

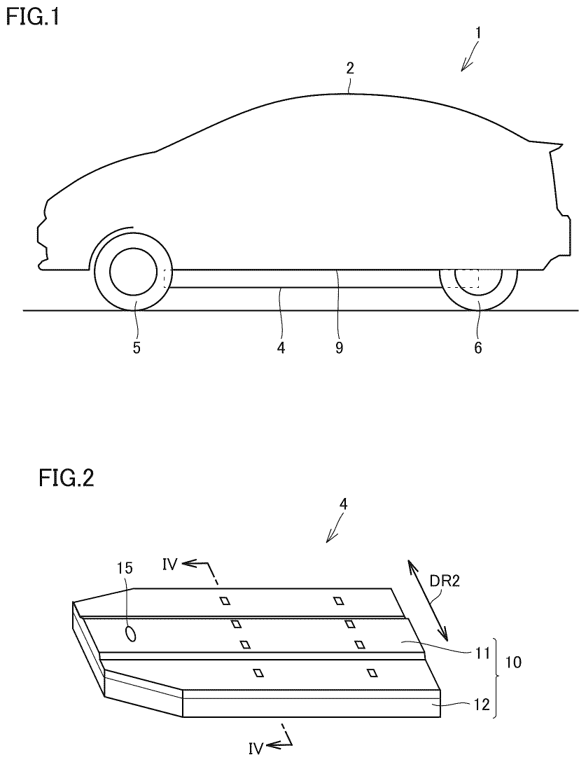

FIG. 1 is a schematic view showing a vehicle equipped with a power storage device according to an embodiment. A vehicle 1 according to an embodiment will be described with reference to FIG. 1.

The vehicle 1 is a hybrid electric vehicle that can travel using power of at least one of a motor and an engine, or an electrically powered vehicle that travels using a driving force obtained by electric energy. The vehicle 1 includes a vehicle body 2, a drive device 3, a power storage device 4, front wheels 5, and rear wheels 6. The vehicle body 2 includes a floor panel 9. The floor panel 9 forms a bottom surface of the vehicle body 2. Power storage device 4 is provided, for example, on the lower surface of floor panel 9. Note that the power storage device 4 may be disposed between the floor panel 9 and the seat.

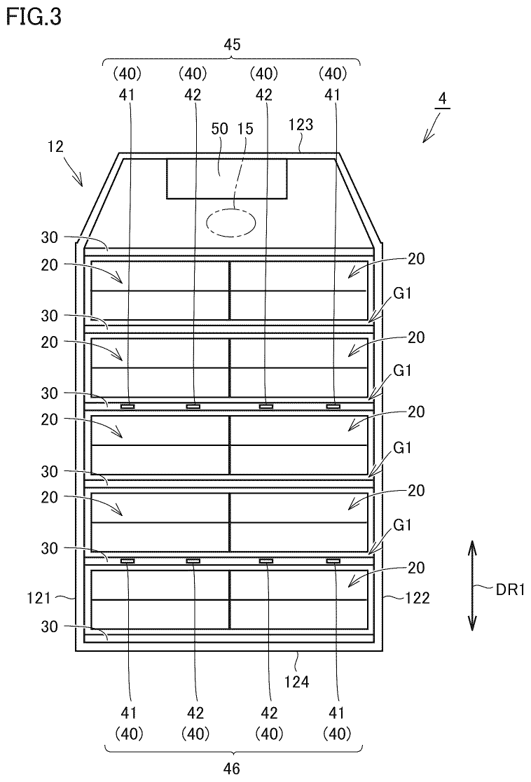

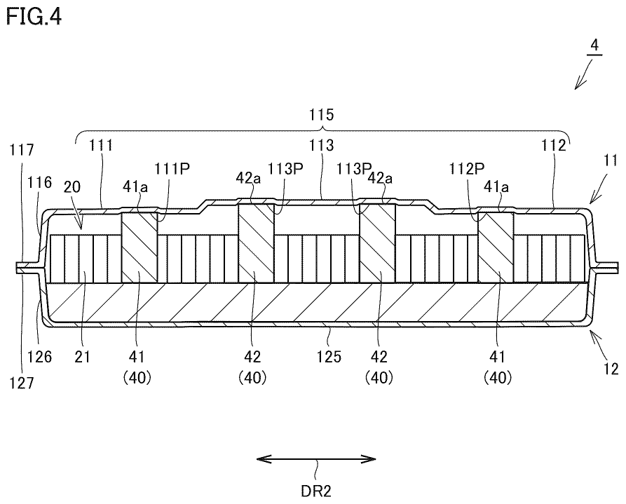

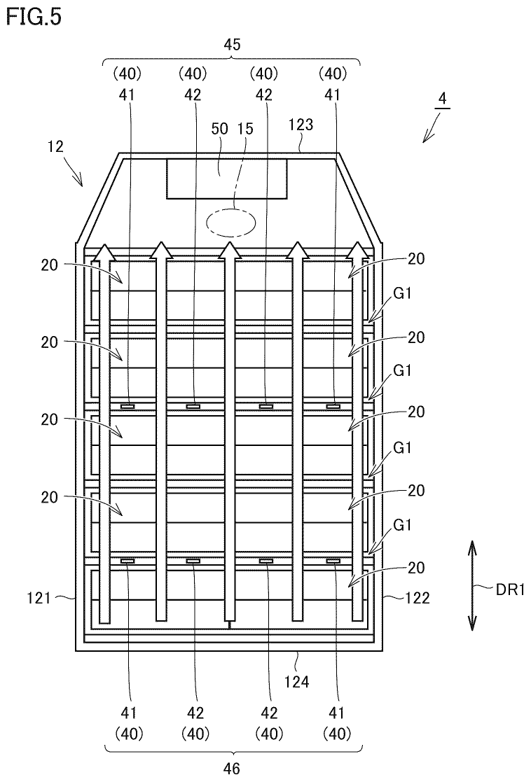

FIG. 2 is a schematic perspective view showing the power storage device according to the embodiment. FIG. 3 is a plan view showing the inside of the power storage device according to the embodiment. FIG. 4 is a cross-sectional view taken along line IV-IV shown in FIG. 2. A power storage device 4 according to an embodiment will be described with reference to FIGS. 2 to 4.

As shown in FIG. 2, the power storage device 4 includes a housing case 10. The housing case 10 is a case body in which a first direction DR1 is a length direction and a second direction DR2 orthogonal to the first direction DR1 is a width direction. The power storage device 4 is mounted on the vehicle 1 such that, for example, the first direction DR1 is parallel to the front-rear direction of the vehicle 1 and the second direction DR2 is parallel to the width direction of the vehicle 1. The height direction of the housing case 10 is orthogonal to the first direction DR1 and the second direction DR2, and is parallel to the top-bottom direction.

The housing case 10 includes an upper case 11 and a lower case 12. The lower case 12 has a box shape that opens upward. The lower case 12 is formed of, for example, a metal material such as an aluminum alloy. The lower case 12 is fixed to the floor panel 9 by a fixing member such as a bracket.

The upper case 11 closes the opening of the lower case 12. The upper case 11 may be formed of a metal material such as an aluminum alloy, or may be formed of a resin or the like. When the upper case 11 is formed of resin, the weight of the housing case 10 can be reduced.

An exhaust valve 15 is provided on one side of the upper case 11 in the first direction DR1. The exhaust valve 15 is configured to open when the pressure in the housing case 10 becomes higher than a predetermined pressure, and discharge the gas in the housing case 10 to the outside of the housing case 10.

As illustrated in FIGS. 3 and 4, the power storage device 4 includes a plurality of power storage modules 20, a plurality of cross members 30, a plurality of support members 40, and an electronic device 50. Although FIG. 3 shows a state in which the upper case 11 is removed from the power storage device 4, the position of the exhaust valve 15 is indicated by a one-dot chain line for convenience.

The plurality of power storage modules 20, the plurality of cross members 30, the plurality of support members 40, and the electronic device 50 are disposed in the housing case 10.

The lower case 12 includes a pair of sidewall portions 121 and 122 facing the second direction DR2, and a first wall portion 123 and a second wall portion 124 facing the first direction DR1.

The plurality of power storage modules 20 are arranged side by side at intervals in the first direction DR1. Each of the plurality of power storage modules 20 includes a plurality of power storage cells 21. The power storage module 20 is configured by arranging a plurality of power storage cells 21 in a row along the second direction DR2. The power storage module 20 may be configured by arranging the plurality of power storage cells 21 in a matrix in which the first direction DR1 is the row direction and the second direction DR2 is the column direction.

The power storage cell 21 is, for example, a secondary battery such as a nickel-metal hydride battery or a lithium ion battery. The power storage cell 21 has, for example, a rectangular shape. The secondary battery may use a liquid electrolyte or a solid electrolyte.

A pressure release valve is provided on the upper surface of the power storage cell 21. The pressure release valve is configured to open when the pressure in the housing of the power storage cell 21 becomes equal to or higher than a predetermined value. When the pressure release valve is opened, the gas in the housing is discharged to the outside of the housing.

The plurality of cross members 30 are disposed at intervals in the first direction DR1. The plurality of cross members 30 also function as partition members that partition an area in which the above-described power storage module 20 is disposed. The plurality of cross members 30 include those disposed between the power storage modules 20 adjacent to each other in the first direction DR1, those disposed on one side in the first direction DR1 with respect to the power storage module 20 located on the most one side in the first direction DR1, and those disposed on the other side in the first direction DR1 with respect to the power storage module 20 located on the most other side in the first direction DR1 direction.

The cross member 30 is provided substantially linearly. The cross member 30 extends along the second direction DR2. The cross member 30 has one end and the other end in the second direction DR2. One end of the cross member 30 is connected to one sidewall portion 121 of the pair of sidewall portions 121 and 122. The other end of the cross member 30 is connected to the other sidewall portion 122 of the sidewall portions 121 and 122. By providing the cross member 30 in this manner, the rigidity of the housing case 10 can be increased.

The plurality of support members 40 are disposed in at least one of the gaps G1 each located between the power storage modules 20 adjacent to each other in the first direction DR1. The plurality of support members 40 support the upper case 11. The upper ends of the plurality of support members 40 are in contact with the upper case 11. The lower end sides of the plurality of support members 40 are fixed to the cross member 30. The cross member 30 may be omitted, and in this case, the lower end sides of the plurality of support members 40 may be fixed to the bottom wall portion 125 of the lower case 12.

The plurality of support members 40 may be formed of a metal member or a resin member.

The plurality of support members 40 include a one-side support member group 45 and an other-side support member group 46. The one-side support member group 45 is located on one side with respect to the other-side support member group 46 in the first direction DR1. In a plan view, the one-side support member group 45 and the other-side support member group 46 are located on the other side with respect to the exhaust valve 15 in the first direction DR1. In a plan view, the one-side support member group 45 is located between the exhaust valve 15 and the other-side support member group 46 in the first direction DR1.

Each of the one-side support member group 45 and the other-side support member group 46 includes a plurality of first support members 41 and a plurality of second support members 42. In each of the one-side support member group 45 and the other-side support member group 46, the plurality of first support members 41 and the plurality of second support members 42 are arranged side by side with an interval in the second direction DR2. The height of the plurality of second support members 42 is higher than the height of the plurality of first support members 41.

The plurality of second support members 42 are disposed at intervals in the second direction DR2 at a center portion in the second direction DR2. The plurality of first support members 41 are disposed so that the plurality of second support members 42 are located therebetween in the second direction DR2.

In the embodiment, the number of the first support members 41 is two and the number of the second support members 42 is two. As will be described later, the number of the first support member 41 and the second support member 42 can be appropriately set as long as the gas discharged from the power storage cell 21 can move toward the exhaust valve 15 along the first direction. The number of the first support members 41 may be two or more, and the number of the second support members 42 may be one or more.

The electronic device 50 is disposed on the first wall portion 123 side. The electronic device 50 is electrically connected to each of the plurality of power storage modules 20 by a wire harness (not shown). The electronic device 50 is electrically connected to an inverter unit provided in the vehicle 1 by a cable or the like drawn out from the housing case 10 to the outside. The electronic device 50 is, for example, a junction box. In a plan view, the electronic device 50 is located on one side of the exhaust valve 15 in the first direction DR1.

As shown in FIG. 4, the upper case 11 has a substantially box shape that opens downward. The upper case 11 includes a top plate portion 115, a peripheral wall portion 116, and a flange portion 117. The top plate portion 115 includes one-side portion (one-side top plate portion) 111 located on one side in the second direction DR2, the other-side portion (the other-side top plate portion) 112 located on the other side in the second direction DR2, and a center portion (center-side top plate portion) 113 located at the center portion in the second direction DR2.

The one-side portion 111, the other-side portion 112, and the center portion 113 each extend in the first direction DR1. The center portion 113 protrudes upward relative to the one-side portion 111 and the other-side portion 112. The exhaust valve 15 is provided on one side of the center portion 113 in the first direction DR1. The peripheral wall portion 116 is provided downward from the peripheral edge of the top plate portion 115. The flange portion 117 is provided so as to be bent outward from the lower end side of the peripheral wall portion 116.

The lower case 12 includes a bottom wall portion 125, a peripheral wall portion 126, and a flange portion 127. The bottom wall portion 125 faces the top plate portion 115 in the top-bottom direction (height direction). The peripheral wall portion 126 is provided upward from the peripheral edge of the bottom wall portion 125. The peripheral wall portion 126 includes the pair of sidewall portions 121 and 122, the first wall portion 123, and the second wall portion 124. The flange portion 127 is provided so as to be bent outward from the upper end side of the peripheral wall portion 126.

In a state where the lower surface of the flange portion 117 and the upper surface of the flange portion 127 are aligned with each other, the flange portion 117 and the flange portion 127 are fastened by a plurality of fastening members. Thus, the upper case 11 and the lower case 12 are fixed.

Here, the plurality of first support members 41 support the one-side portion 111 and the other-side portion 112 of the top plate portion 115. The plurality of second support members 42 support the center portion 113 of the top plate portion 115. Therefore, the upper case 11 can be more firmly supported, and the vibration isolation property of the upper case 11 can be improved.

The one-side portion 111 and the other-side portion 112 are provided with first housing protrusions 111P and 112P which protrude upward and in which respective upper end portions 41a of the first support members 41 are received. The plurality of first housing protrusions 111P and 112P are provided at positions corresponding to the plurality of first support members 41. The center portion 113 is provided with a plurality of second housing protrusions 113P which protrude upward and in which respective upper end portions 42a of the plurality of second support members 42 are received. The second housing protrusion 113P is provided at a position corresponding to the second support member 42. As described above, when the number of the second support members 42 is one, one second housing protrusion 113P is provided.

Since the upper end portions 41a are received in the first housing protrusions 111P and 112P and the upper end portion 42a is received in the second housing protrusion 113P, movement of the plurality of first support members and one or more second support members can be suppressed. As a result, the vibration isolation property of the upper case 11 can be further improved.

FIG. 5 is a diagram showing a state in which the gas moves in the housing case when the gas is discharged from the power storage module in the power storage device according to the embodiment. FIG. 5 shows a plan view in which the upper case 11 is omitted from the power storage device 4, but the exhaust valve 15 provided in the upper case 11 is shown by a one-dot chain line for convenience.

As shown in FIG. 5, when the gas is discharged from the power storage module 20, the gas moves toward one side in the first direction in which the exhaust valve 15 is provided, as indicated by an outline arrow in the drawing. At this time, as described above, the upper case 11 is provided with the center portion 113 protruding upward from the one-side portion 111 and the other-side portion 112. Accordingly, the gap between the center portion 113 and the power storage module 20 is wider than the gap between the one-side portion 111 and the other-side portion 112 and the power storage module 20. Therefore, even when the gas is discharged from the power storage module 20, it is possible to sufficiently secure the exhaust path through which the gas can move. In addition, since the plurality of first support members 41 and the one or more second support members 42 are disposed apart from each other, the gas can move therebetween, so that the gas exhaust path can be sufficiently secured.

The first support member 41 and the second support member 42 may have a lattice shape in which a plurality of through holes penetrating in the first direction are provided with openings arranged in a matrix in the top-bottom direction and the second direction DR2 direction. In this case, it is possible to suppress the movement of the gas from being hindered by the first support member 41 and the second support member 42 due to the movement of the gas in the opening. Thus, the exhaust path can be further secured.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a plurality of power storage modules arranged in a first direction orthogonal to a top-bottom direction;
a housing case including an upper case and housing the plurality of power storage modules; and
a plurality of support members that are arranged in at least one of gaps each located between the power storage modules adjacent to each other in the first direction, and support the upper case, wherein
an exhaust valve that allows gas in the housing case to be discharged is provided on one side, in the first direction, of the upper case,
the upper case includes a one-side top plate portion located on one side in a second direction orthogonal to the first direction, an other-side top plate portion located on the other side in the second direction, and a center-side top plate portion located in a center portion in the second direction,
the one-side top plate portion, the other-side top plate portion, and the center-side top plate portion each extend in the first direction,
the center-side top plate portion protrudes upward relative to the one-side top plate portion and the other-side top plate portion, and
the plurality of support members include a plurality of first support members supporting the one-side top plate portion and the other-side top plate portion, and one or more second support members supporting the center-side top plate portion.

2. The power storage device according to claim 1, wherein
each of the one-side top plate portion and the other-side top plate portion includes a first housing protrusion which protrudes upward and in which an upper end of the first support member is received, and
the center-side top plate portion includes one or more second housing protrusions which protrude upward and in which respective upper ends of the one or more second support members are received.
